(19) United States
(12) Patent Application Publication
(10) Pub. No.: US 2007/0073595 A1
(43) Pub. Date: Mar. 29, 2007

(54) Systems and Methods to Facilitate Commerce in the Vehicle Aftermarket

(76) Inventor: Thomas John Moore, Seal Beach, CA (US)

Correspondence Address: LAW OFFICE OF MICHAEL P. EDDY, 12526 HIGH BLUFF DRIVE, STE. 300, SAN DIEGO, CA, 92130, US

(21) Appl. No.: 11/425,140

(22) Filed: Jun. 19, 2006

Related U.S. Application Data
(60) Provisional application No. 60/691,117, filed on Jun. 17, 2005.

(51) Int. Cl. G06Q 30/00

(52) U.S. Cl. 705/26

(57) ABSTRACT

A system and method for facilitating commerce, the system and method including the steps of allowing a user to select one or more items from a list presented to the user, associating the one or more items with at least one alias, mapping the one or more items into a preselected format and cataloging the mapped data so that it can be accessed by at least the user, so that the mapped data is integrated with a storefront so that the items may be located and sold using the mapped data.

### CROSS-REFERENCES TO OTHER RELATED PATENT APPLICATIONS

The present application claims priority to U.S. provisional application Ser. No. 60/691,117 filed Jun. 17, 2005, all of which is incorporated herein by reference in its entirety.

### STATEMENT REGARDING FEDERALLY SPONSORED RESEARCH OR DEVELOPMENT

None.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The invention generally relates to systems and methods used to facilitate commerce on computer networks as well as in commercial establishments. More particularly, embodiments of the claimed subject matter relate to online e-commerce in the field of vehicle aftermarkets.

### SUMMARY

Embodiments of the claimed subject matter include systems and methods for facilitating commerce in the vehicle aftermarket, the systems and methods including the steps of allowing a user to select one or more items from a list presented to the user, associating the one or more items with at least one alias, mapping the one or more items into a preselected format and cataloging the mapped data so that it can be accessed by at least the user, so that the mapped data is integrated with a storefront so that the items may be located and sold using the mapped data.

Further aspects of the invention will become apparent from consideration of the drawings and the ensuing description of the several embodiments of the claimed subject matter. A person skilled in the art will realize that additional variations and embodiments of the claimed subject matter are possible and that the details of each of the embodiments can be modified in a number of respects, all without departing from the scope of the claimed subject matter. Thus, the following drawings and description are to be regarded as illustrative in nature and not restrictive.

### BRIEF DESCRIPTION OF THE DRAWINGS

The features of the invention will be better understood by reference to the accompanying drawings which illustrate several embodiments of the claimed subject matter. In the drawings:

FIG. 1 is an overview according an embodiment of the claimed subject matter;

FIG. 2 is a diagram showing a commerce based embodiment;

FIG. 3 is a flow chart showing a prior art manual ordering process;

FIG. 4 is a flow chart showing an embodiment according to the claimed subject matter;

FIG. 5 is an image of a computer screen showing various advertising options of an embodiment according to the claimed subject matter;

FIG. 6 is an image of another computer screen displaying the addition of vehicle parts according to an embodiment of the claimed subject matter;

FIG. 7 is an image of another computer screen showing the assignment of characteristics to one or more parts in an embodiment of the claimed subject matter;

FIG. 8 is an image of another computer screen showing the assignment of related parts in a system according to an embodiment of the claimed subject matter;

FIG. 9 is an image of a computer screen for selecting parts in a system according to an embodiment of the claimed subject matter;

FIG. 10 is an image of a computer screen for editing a part in a system according to an embodiment of the claimed subject matter; and

FIG. 11 is an image of a computer screen for assigning an engine in an embodiment of the claimed subject matter.

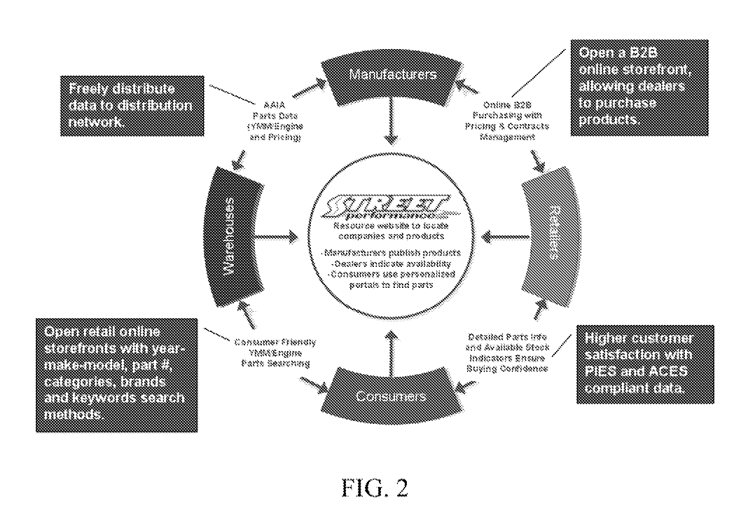

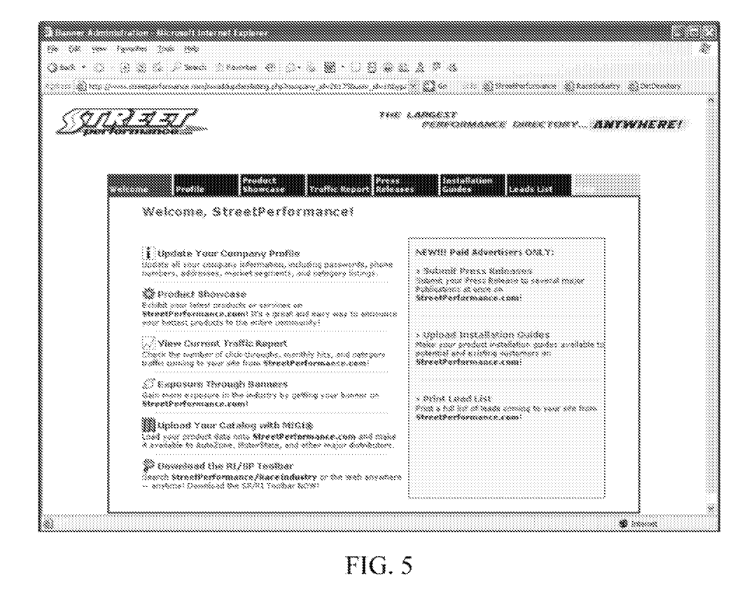

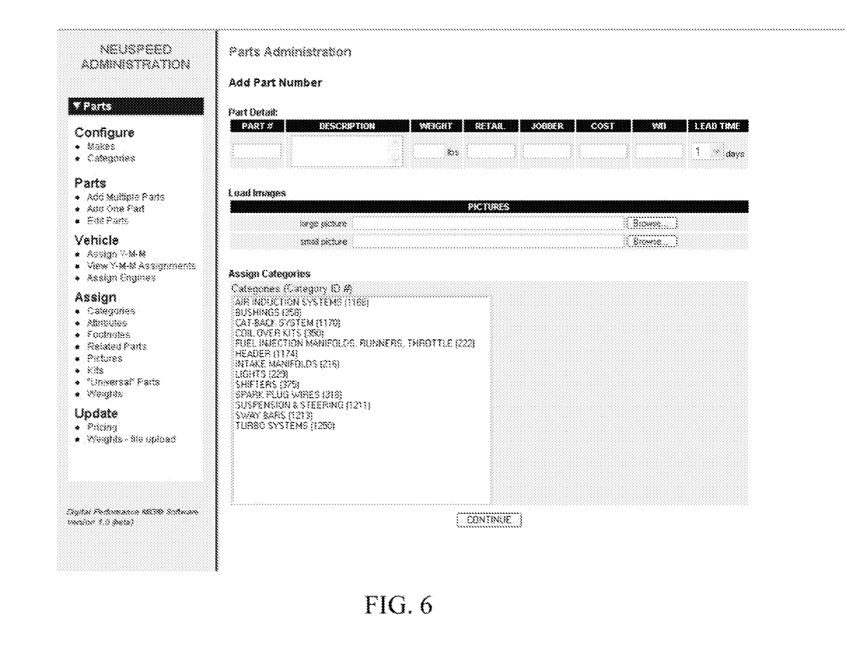

### DETAILED DESCRIPTION OF THE EMBODIMENTS

With reference now to the various figures in which identical elements are numbered identically throughout, a description of various exemplary aspects of the present invention will now be provided.

Referring now to FIG. 1, a first embodiment of a system and method to facilitate commerce in the vehicle aftermarket is shown. This embodiment has been marketed as the MIGI™ eCommerce software solution by Digital Pages, Inc., doing business under several names including Digital Performance, Inc. This embodiment is an internet based embodiment although other embodiments can be implemented on other networks or without a network.

The present embodiment includes eCataloging and eCommerce elements and is comprised of two modules, now branded the MlCatalog and the MIStore. These modules allow vehicle data to be mapped to MIA industry standards and they allow the mapped data to be exported to online storefronts for creating and maintaining business applications such as retail to consumer and business-to-business applications.

Utilizing this embodiment, manufacturers, distributors arid retailers can centralize, own and maintain their product data in a format that is compliant or equal to AAIA's year-make-model engine industry standards. Other standards may also be used. In some embodiments, users may also release their mapped and/or cataloged data in order to keep customers and trading partners up-to-date, reducing product time-to-market. Users of the embodiments may also use the mapped and/or cataloged data to create and maintain one or more comprehensive retail or B2B online storefronts, complete with dealer and price level management, multiple search methods, order history and sales reports.

Users such as manufacturers and distributors can also publish their product data to centralized information storehouse web sites or platforms, such as the one maintained at the internet web site StreetPerformance.com, so their products may be found by consumers and businesses seeking aftermarket products and services. The product data may also be integrated into the user's own product search algorithms and methods on the user's own systems and web sites.

The visual presentation of the electronic product assists the user and consumers in searching for one or more parts by various fields. These fields include the year-make-model, engine, and part catalog number. These fields can be adapted to the user's individual requirements such as the company number, keywords and/or categories. The data can be easily adapted to be used across more than one e-commerce platforms.

Web sites can use the data with a variety of other web site components, such as a secure server shopping cart and database systems such as MySQL or an Oracle database solution. The present embodiment include the following features and component interface screens: Orders Admin, Order Administration, Shipping Administration, Credit Card Administration, Parts Admin, Configure, MlStore, Editing a new or existing Company, Car Makes, Categories, Attributes, Parts, Adding One Part Adding Multiple Parts, Editing Parts, Vehicles, Assigning V-M-M, Assigning Engines Assign, Assigning Categories, Assigning Attributes, Assigning Weights/Actual Shipping, Pictures, Assigning Pictures to a Part, Uploading Pictures, Footnotes, and Assigning Footnotes to a Part, Adding a Footnote, Editing a Footnote, Deleting a Footnote, Assigning Universal Parts, Assigning Kits to Parts, Assigning Related Parts, Global Updates, Pricing, Weights—File Upload, Home Page, Products, Featured Parts, Customizing Homepage with Product Specials, Removing a Product Special, Home Page Categories, Featured Categories, Configuring Categories to Products Removing a Company, Assigning an Image to a Category, Home Page HOT BUYS, Assigning HOT BUYS, Removing HOT BUYS, Home Page Pictures, Uploading Pictures to the Homepage, Content Manager, Featured Article/Tech Article/News Item Creating an Article, Editing an Article, Promotions Admin, Coupons, Creating a New Custom Coupon, Editing an Existing Coupon, Bulk Emails, Send a Bulk Email, Private Label Admin, Assigning Private Label Parts, Editing a Private Label Part, Deleting a Private Label Part, Categories Admin, Edit a Parent Category, Add a New Category, Suppliers Admin, Suppliers Administration, Adding New Suppliers, Editing Suppliers, Dealer Admin, Price Levels, Adding a Price Level, Editing a Price Level, Dealers, Adding a New Dealer, Editing a Dealer, and Deleting a Dealer.

Other features and component interface screens include Assigning Levels/Discounts, Assigning Price Levels, Assigning Payment Methods, Adding a Product line Discount, Removing a Product line Discount, Shopping Cart Report, Viewing Top Selling Companies, Viewing Parts Sold, and Review and Export Data.

In the Order Administration area, orders may be viewed, edited, or deleted using various features and component interface screens including Quick Search, for example using variables of first name, last name and order number, Input query, i.e. name or order number which can be found in the query box so that records can be retrieved or pulled up based on the specific query. A “Go” button may also be included to complete one or more functions.

The View Orders function includes features to view one or more orders according to the order type. For example, the order type can be: Cancelled, Closed, Open, Return Pending, and Returned. The order list may also be sorted by the Sort Orders feature. This feature allows a user to select how a list is sorted by choosing a type of field to be sorted upon. For example, order number, last name or the order date fields.

The details of these as well as other features of the multiple embodiments are describes below in outline format.

Order Administration

To view, edit, or delete orders, simply use one or more of the following options.

Quick Search (first/last/name/order#)

Input query—i.e. name or order number—in the box to pull up records based on the specific query. Press “Go” button to complete.

View Orders

Views order according to type: Cancelled, Closed, Open, Return Pending, Returned. Select type and press the “Go” button to the right.

Sort List By

Select how list is sorted by choosing a type—Order #, Last Name or Date—and pressing “Go.”

To ADD Credits or Extra Charges

Step 1: Select the Order that needs to be changed.

Step 2: In the field labeled: “Reason for Change,” enter reason.

Step 3: Enter the amount to be credited or charged in the appropriate fields.

Step 4: Press the appropriate button—“Credit” to credit account, “Charge” to charge account—to complete transaction.

To CHANGE Order Status

Step 1: Select the Order that needs to be changed.

Step 2: In the field labeled: “Reason for Change,” enter reason.

Step 3: Select the appropriate status (Cancelled, Closed, Open, Return Pending, Returned) from the pull down menu.

Step 4: Press “Update” to complete transaction.

Shipping Administration

To View Open Orders by Company

Select the link for the appropriate company.

To Change the View of Orders to See Cancelled, Closed, Open, Return Pending, or Returned.

Select the view you want to see from the pull down menu at the top of the page, and press “Orders”.

To Update Orders

Step 1: Select appropriate changes:
SHIPD for Shipped
EMAIL for Email
To select Shipping Company, select the correct company from the pull down menu.
Enter the Tracking # in the specified field.
To enter “NOT SHIPPED/REASON” “EST SHIP DATE” or “REDIRECT ITEM” select the appropriate reason from the pull down menu.

Step 2: Press “UpdateOrders” to complete transaction.

Credit Card Administration

When a user clicks on the “credit card admin” link, a new window will pop up with the VeriSign Manager and the user can login using the user's Merchant Login and Password to make any changes using the VeriSign Manager.

To Change the View of Orders to See Cancelled, Closed, Open, Return Pending, or Returned:

Select the view you want to see from the pull down menu at the top of the page, and press “Orders”.

To Update Orders:

Step 1: Select appropriate changes:
SHIPD for Shipped
EMAIL for Email
To select Shipping Company, select the correct company from the pull down menu.
Enter the Tracking * in the specified field,
To enter “NOT SHIPPED/REASON” “EST SHIP DATE” or “REDIRECT ITEM” select the appropriate reason from the pull down menu.

Step 2: Press “UpdateOrders” to complete transaction.

Credit Card Administration

When a user clicks on the “credit card admin” link, a new window will pop up with the VeriSign Manager. Once the user has logged in using the user's login and password, the user can make any desired changes. The following includes features related to the Parts Admin module:

If more than one vendor is present, the user can select the company that the user wants to edit by choosing from the pull down menu in the left column. If the user desires, he or she can edit an entire category by selecting the category from the pull down menu in the left column.

Configure

Customizing MIStore
Step 1: Enter Contact Information in the appropriate fields.
Step 2: Select the features that you would like on MIStore.
Step 3: Enter Home Page Name and Click the “Next” button.
Step 4: To upload your header image, click on the “Browse” button to select a file on your computer. Locate the image in your computer and click on the “Open” button.
(The header must be 749 pixels wide×108 pixels high, if your header exceeds these dimensions, please use a photo editing program to crop the image to size).
Step 5: Choosing Colors
   Click on the icon with the artist's palette to view the color menu, click on the color that you want for each of the color options.
   Template Color 1 is the background color behind the text.
   Template Color 2 is the accent color bar next to the text background color.
   Background Color is the color that goes behind everything on the entire page.
   Font Color is the color of the header texts.
   To select a background pattern, simply select the pattern that you want.
   This pattern will be laid over the background color.
   Click on “Preview” to preview color combination.
Step 6: Fill in the title names for each of the sections.
Step 7: Company Description
   Input Company Keywords: These keywords will help you get listed high on the search engines. Keywords include the products you sell and/or industry you are in.
   Input Company Description: This is a brief description of your company; it will be in the Meta tag and MIStore page. Descriptions include something about your company and/or the services that you provide.
   Input Title: This is the title that you would like for your pages. This should include your company name and a few keywords.
Step 8: Searches
   Select type of searches you would like on your MIStore by clicking on the search category you would like.
Step 9: Uploading Logo and Slogan Images
   1. To upload an image click on the “Browse” button.
   2. Locate the image on your computer that you want for your logo and tag.
   3. Click “Open.”
Step 10: Click on the “Submit” button to complete changes.

Editing a Company
To Add a Company
Fill in the company's name in field named: “Company Name” and press the “Add” button.
To Edit or Delete a Company
   Step 1: Select a company from the pull down menu at the top of the Parts Admin menu, click on the “edit/delete company” link.
   Step 2: On the right side of the window, you will be able to make edits to the company name, description and changes in logo.
   Step 3: To update company info, simply make the necessary changes to the information and click the “Update Company Info” button.
   Step 4: To delete company info, simply click on the “Delete Company” button.
   Step 5: To change the logo click on the “Browse” button and locate on your computer the new image that you want to use and click the “Open” button. Click on the “ADD New Pictures” button to complete the upload.
   Note: Large logos must not exceed 100 pixels wide and small logos must not exceed 45 pixels wide, please use a photo editing program to crop any images larger than these dimensions.

Car Makes
To Configure Models
   Step 1: Select a make or makes from the menu
   Note: Selecting multiple companies here will slow MIGI down.
   Step 2: Click on “Update.”
   Step 3: Highlight the part number(s) in the left table and highlight the model(s) in the right table.
   To select more than one number or model at a time, press the Control [Ctrl] key while clicking on the item you want to select. If you wish to select groups of numbers or models, simply highlight the first group and then hold down the Control [Ctrl] to select additional groups.
   Step 4: Click on “Assign.”

Categories
To Assign a Category to Your Product Select a category or categories from the menu that applies to your products and click on “ADD” to assign them.
Do a Quick Search by inputting a category in the field and clicking on the “Quick Search” button.
To select multiple categories, hold down the Control [Ctrl] button while selecting. If you wish to select groups of categories, simply highlight the first group and then hold down the Control [Ctrl] to select additional groups.
To Remove a Category Simply click on the “[remove]” link to the right of the category.

Attributes
To Add a Value to an Existing Attribute Select an attribute from the left table and enter new values in the boxes below and click on the “Add” button.
To Add a NEW Attribute
   Step 1: Will the values for this new attribute be TEXT or NUMERIC? Select the option for the value you want.
   Step 2: Fill in the Attribute's Name.
   Step 3: If a Unit of Measure is applicable, select the appropriate option from the dropdown menu.
   Step 4: To enter the Attribute Values, type the values in the fields under “Attribute Values.”
   Step 5: Click on the “ADD ATTRIBUTE” button.
Listed attributes cannot be deleted.
   Parts

Adding/Editing Parts
To Add One Part
   Step 1: Simply enter the details in the applicable fields.
   Step 2: To load an image to represent the item:
      1. Click on “Browse” button; locate the image on your computer and click “Open.”
      A Thumbnail picture is a small fast loading image. It should not exceed 130 px wide, if it should, please use a photo editing program to crop the image to size.
      A Large Picture is a larger more detailed, but slower loading, image of the product. It should not exceed 450px wide, if it should, please use a photo editing program to crop the image to size.
      2. Click on and highlight the appropriate category for the part.
      3. Click on “CONTINUE.”
To Add Multiple Parts
   Step 1: Format an Excel Spreadsheet according to these specifications:
      Column A—Part #
      Column B—Description
      Column C—Retail Price
      Column D—Jobber Price
      Column E—Cost Price
      Column F—WD Price
      Column G—Weights
      Column H—OEM/Alternate Part #
      Your data may look similar to the following:

Table 1 shows an example of an entry related to the fields described in Step 1 above:

TABLE 1

| | A | B | C | D | E | F | G | H |
|---|---|---|---|---|---|---|---|---|
| 1 | 100A | Brake Pads for Nissan 300ZX | 300.00 | 225.00 | 179.00 | 150.00 | 10.00 | oem2343 |
| . . . | | | | | | | | |

Remove any Commas in the data as they sometimes interfere with the load (In Excel go to Edit>Replace . . . and put in a comma in the top and nothing in the bottom and click “Replace”).
If you have less than 5 columns, enter a 0 at the top of each of the empty columns to prevent any problems.
Make sure there are no descriptions in the header describing the fields. The first row of the Excel sheet must contain data for the first part.
Step 2: Save the worksheet in Excel format and close the document.
Step 3: Upload the Excel file
Click on “Browse” and locate the appropriate file on your computer. Click on “Open.”
If you want to overwrite the current descriptions of existing products, click on the box to select it.
Step 4: Click on “Next.”
Check to see that the data uploaded is correct. If something is incorrect, try to modify the Excel Spreadsheet, save it and re-upload the file to MIGI.
Step 5: Click on “Upload Data into System” to complete changes in MIGI.

Edit Existing Parts
Step 1: Select the part(s) you want to edit and click on “EditParts.”
To find a specific part by part number, simply enter the part number in the field and press the “GO” button.
To sort the parts list by Description, Part # or Category, simply select the order in which you want the list sorted and click on “SORT”.
To sort the Makes & Models list, use the box above the table containing all the models. Enter the start year and end year, select an option from the “Show” and/or “Vehicle” pull down menus and press “GO”.
To select multiple part numbers at a time, hold down the Control key [CTRL] while selecting. If you wish to select groups of parts, simply highlight the first group and then hold down the Control [Ctrl] to select additional groups.
Step 2: Make any necessary edits in the next screen and click on “GLOBAL UPDATE.”

To DELETE a part
Step 1: Highlight the part(s) you want to delete and click on “DELETEParts.”

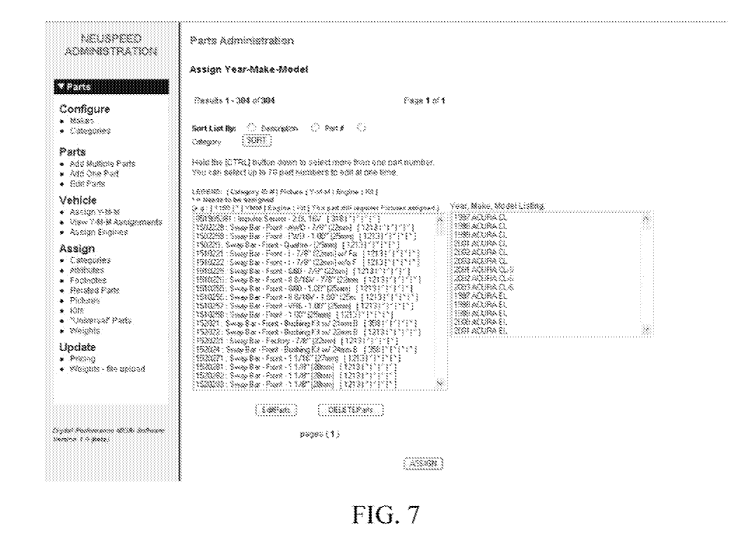

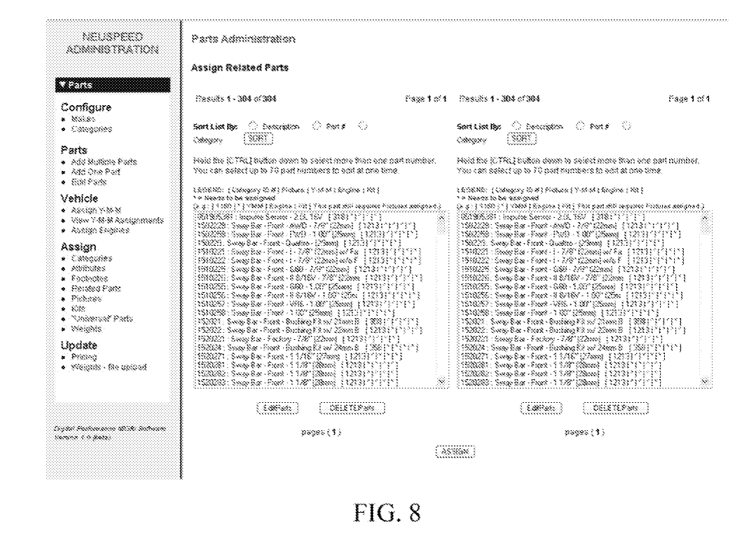

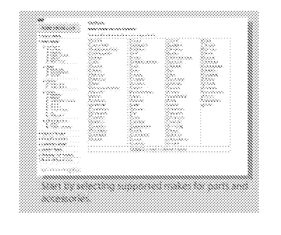

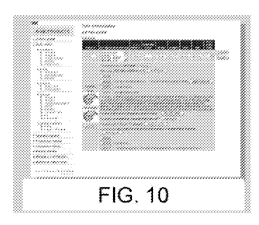

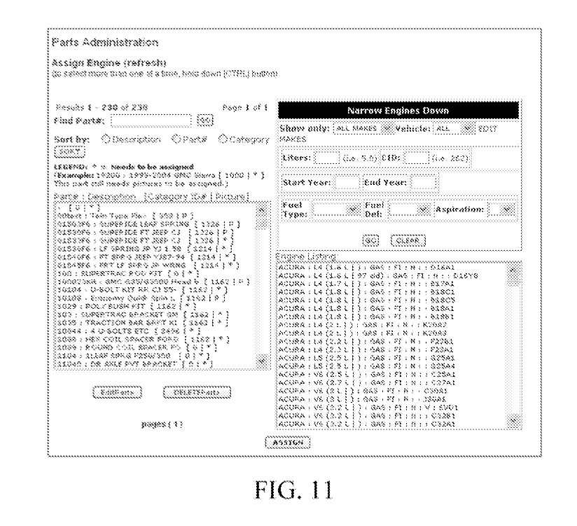

FIGS. 7 through 11 are images of computer screen showing various features of embodiments of the claimed subject matter. As shown in FIG. 7 and similarly in FIGS. 8 through 11, the following steps are shown:
Step 1: Choose the part(s) you want to assign.
   To find a specific part by part number, simply enter the part number in the field and press the “GO” button.
   To sort the parts list by Description, Part # or Category, simply select the order in which you want the list sorted and click on “SORT.”
   To select multiple part numbers at a time, hold down the Control key [CTRL] while selecting. If you wish to select groups of parts, simply highlight the first group and then hold down the Control [Ctrl] to select additional groups.
Step 2: Select the part's corresponding Make & Model
   To view select cars makes and models, do one or more of the following:
      Enter a Start and End Year
      Select a Make from the dropdown menu.
      Clicking on the “EDIT” link pops up a new window in which you can select from a menu of car makes. Make your selection(s), click on “UPDATE” close the popup window, and click on the “(refresh)” link to show changes.
      Select a Vehicle option from the dropdown menu.
      Click “GO” to sort.
Step 3: Click “ASSIGN. As shown, the * indicated that the part needs to be assigned. (Example: 19200: 1999-2004 GMC Sierra [1000|*] This part still needs a picture to be assigned.)
   Attributes

To Assign an Attribute
Step 1: Select the part(s) you want to assign
To find a specific part by part number, simply enter the part number in the field and press the “GO” button.
To sort the parts list by Description, Part # or Category, simply select the order in which you want the list sorted and click on “SORT”.
To select multiple part numbers at a time, hold down the Control key [CTRL] while selecting. If you wish to select groups of part numbers, simply highlight the first group and then hold down the Control [Ctrl] to select additional groups.
Step 2: Select the corresponding attribute(s).
Step 3: Click on “ASSIGN.”
Legend: *=Needs to be assigned. (Example: 19200: 1999-2004 GMC Sierra [1000|*] This part still needs a picture to be assigned.)

Weights/Actual Shipping

To assign weights/actual shipping
Step 1: Select the part(s) you want to assign.
To find a specific part by part number, simply enter the part number in the field and press the “GO” button.
To sort the parts list by Description, Part # or Category, simply select the order in which you want the list sorted and click on “SORT”.
To select multiple part numbers at a time, hold down the Control key [CTRL] while selecting. If you wish to select groups of part numbers, simply highlight the first group and then hold down the Control [Ctrl] to select additional groups.
Step 2: Enter the Weight and/or Actual Shipping (applies to certain distributors) and click on the button below the field.
Legend: *=Needs to be assigned. (Example: 19200: 1999-2004 GMC Sierra [1000|*] This part still needs a picture to be assigned.)

Pictures

To Assign Pictures
Step 1: Select the part(s) you want to assign.
To find a specific part by part number, simply enter the part number in the field and press the “GO” button.
To sort the parts list by Description, Part # or Category, simply select the order in which you want the list sorted and click on “SORT”.
To select multiple part numbers at a time, hold down the Control key [CTRL] while selecting. If you wish to select groups of part numbers, simply highlight the first group and then hold down the Control [Ctrl] to select additional groups.
Step 2: Enter the Weight and/or Actual Shipping (applies to certain distributors) and click on the button below the field.
Step 3: Click on “ASSIGN”

To Upload Pictures
Large Pictures may not exceed 450px wide, and small picture may not exceed 130px wide if it should, please use a photo editing program to crop image to size.
Step 1: Click on the “Browse,” locate and highlight the image on your computer and click on “Open.”
Step 2: Click on “ADD New Pictures.”
Legend: *=Needs to be assigned. (Example: 19200: 1999-2004 GMC Sierra [1000|*] This part still needs a picture to be assigned.)

Footnotes

To Assign a Footnote to a Part
Step 1: Click on the part(s) that you want to assign.
To find a specific part by part number, simply enter the part number in the field and press the “GO” button.
To sort the parts list by Description, Part # or Category, simply select the order in which you want the list sorted and click on “SORT”.
To select multiple part at a time, hold down the Control key [CTRL] while selecting. If you wish to select groups of parts, simply highlight the first group and then hold down the Control [Ctrl] to select additional groups.
Step 2: Click on its corresponding footnote and click on “ASSIGN.”

To ADD a Footnote
Step 1: Simply type or copy and paste the new footnote into the field at the bottom of the page.
Note: You may use HTML code within your footnote. The code to link to an outside document (i.e. a PDF or another website) is
<a href=“[document name or website address]”>[insert the link name]</a>
Make sure to remember to have the </a> at the end of your link as this closes the tag.
Step 2: Click on “NEW FOOTNOTE.”

To EDIT a Footnote
Step 1: Highlight the footnote and click on “EDIT.”
Step 2: Make your changes and click on “SAVE.”

To DELETE a Footnote
Step 1: Highlight the footnote
Step 2: Click “DELETE.”

“Universal” Parts

To Assign “Universal” Parts
Step 1: Click on the part(s) you want to assign.
To find a specific part by part number, simply enter the part number in the field and press the “GO” button.
To sort the parts list by Description, Part # or Category, simply select the order in which you want the list sorted and click on “SORT”.
To select multiple parts at a time, hold down the Control key [CTRL] while selecting. If you wish to select groups of parts, simply highlight the first group and then hold down the Control [Ctrl] to select additional groups.
Step 2: Click “ASSIGN UNIVERSAL”.
Legend: *=Needs to be assigned. (Example: 19200: 1999-2004 GMC Sierra [1000|*] This part still needs a picture to be assigned.)

Kits

To Assign Kits to Parts
Step 1: Click on an existing part number to create a kit.
To find a specific part by part number, simply enter the part number in the field and press the “GO” button.
To sort the parts list by Description, Part # or Category, simply select the order in which you want the list sorted and click on “SORT”.
To select multiple part numbers at a time, hold down the Control key [CTRL] while selecting. If you wish to select groups of part numbers, simply highlight the first group and then hold down the Control [Ctrl] to select additional groups.
Step 2: Click on the parts related to kit.
   To find a specific part by part number, simply enter the part number in the field and press the “GO” button.
   To sort the parts list by Description, Part # or Category, simply select the order in which you want the list sorted and click on “SORT”.
Step 3: Click on “ASSIGN.”

Related Parts

To Assign Related Parts
Step 1: Select the part(s) you want to assign.
To find a specific part by part number, simply enter the part number in the field and press the “GO” button.
To sort the parts list by Description, Part # or Category, simply select the order in which you want the list sorted and click on “SORT”.
To select multiple part numbers at a time, hold down the Control key [CTRL] while selecting. If you wish to select groups of part numbers, simply highlight the first group and then hold down the Control [Ctrl] to select additional groups.
Step 2: Select Manufacturer from the pull down menu.
Step 3: Enter Part Number.
Step 4: Repeat for additional parts. (If applicable).
Step 5: Click on “ASSIGN.”
   Global Updates

Pricing
Format an Excel spreadsheet with the following guide instructions.
Make sure the pricing does not have commas or dollar symbols (to format this in Excel, go to Format>Column>Number [with 2 decimals]).
Step 1: Format the data as follows:
   Column A—Part #
   Column B—Racer Price (Retail)
   Column C—Jobber
   Column D—Stocking Jobber
   Column E—WD Price
   Column F—Master WD (MWD) Price

Your data should look similar to the following Table 2:

TABLE 2

| | A | B | C | D | E | F |
|---|---|---|---|---|---|---|
| 1 | 100A | 300.00 | 225.00 | 179.00 | 150.00 | 100.00 |
| . . . | | | | | | |

Note: Make sure there are no descriptions in the header describing the fields. The first row of the Excel sheet must contain data for the first part.
Step 2: Save the Excel spreadsheet by going to File>Save As
Save the worksheet as a CSV (comma delimited) file—you can find this option by clicking on the pull down menu for “Save as type” and selecting CSV (comma delimited).
Step 3: Upload the CSV file to MIGI.
To upload file, click on the “Browse” button in Step 5. Locate the saved CSV file on your computer and click on the “Open” button (Do NOT upload the Excel file!)
Step 4: Click on the “Submit” button to upload changes.

Weights—File Upload
To update weights, format an Excel spreadsheet with the following guide instructions. (Note: These instructions are different than the instructions for Pricing changes!)
Step 1: Format the data as follows:
   Column A—Part #
   Column B—Weights
   Column C—Actual Shipping
   Column D—Dimensions (H×L×W)
   Column E—Unit of Measure (inch, ft, cc, cm)
   Column F—UPC Code

Your Data should look similar to the following table:

TABLE 3

| | A | B | C | D | E | F |
|---|---|---|---|---|---|---|
| 1 | 100A | 12.00 | 20.00 | 10 × 10 × 2 | inch | UPC102342404 |
| . . . | | | | | | |

Be sure to remove all Commas to avoid any problems. (You can do this quickly by going to Edit [in the toolbar]>Replace to find all the commas and delete them out).
Note: Make sure there is something in the first cell of each column. If there is a column you are not using, put a 0 in the first cell. Also, make sure there are no descriptions in the header describing the fields. The first row of the Excel sheet must contain data for the first part.
Step 2: To save the Excel spreadsheet, go to File>Save As
Save to worksheet in Excel Format, it should the default file type that Excel saves to.
Step 3: To upload the Excel file, click on the “Browse” button, locate the file on your computer, and click on “Open” button.
Step 4: Click on the “Next” button to continue.
   Home Page Products

Featured Parts

Customizing Homepage with Product Specials
Step 1: From the “All Products Available” menu, select the part(s) that you want to assign Product Specials.
Step 2: Click on “ASSIGN PRODUCTS.”

Removing a Product Special
Step 1: Select the Part you want to remove from the “Currently Selected Products” menu.
Step 2: Click on “RLMOVEPL.”
   Home Page Categories

Featured Categories

Configuring Categories to Products
Step 1: Select an available category.
Step 2: Select a product.
Step 3: Click “ASSIGN CATEGORIES.”

Removing a Company
Step 1: Click on the company you want to remove.
Step 2: Click “REMOVE COMPANIES.”

Assigning an Image(s) to Go With a Category
Step 1: Click “Browse”
Step 2: Locate and select the image you want to use on your computer.
Step 3: Click “Open.”
Step 4: Click “Assign Categories.”
   Home Page HOT BUYS

Assigning Hot Buys
Step 1: Select the product that you want to assign as a “Hot Buy.”
Step 2: Click on “ASSIGN HOT BUY.”

Removing Hot Buys
Step 1: Select the Hot Buy you want to remove.
Step 2: Click on “REMOVEPL.”
   Home Page Pictures

Uploading Pictures to Home Page
Step 1: Click on the “Browse” button on the right hand side of the page.
Step 2: Locate where the image is on your computer and press the “Open” button.
Images should be no larger than 450 pixels wide with a resolution of 72 dpi, if it exceeds this width and resolution, use a photo editing program to crop the picture to size.
Step 3: In the “URL to point Picture” field enter the URL that you want this picture to link to. (If Applicable).
Step 4: To complete upload, click on the “ADD New Pictures” button.
   Content Manager

Featured Article/Tech Article/News Item

Creating an Article
Step 1: Select which type of article you would like to create by clicking on the link in the menu on the left hand side of the MIGI program.
Step 2: Input Article Title.
Step 3: Upload picture(s).
Step 4: Type or copy and paste in Article Text. This window works similar to a Word Document.
To change the font, font size, justification, font color, etc., use the tool bar directly above the content window.
Step 5: Click on “SUBMIT.”

To EDIT an Article
Step 1: Select the article you want to from the dropdown menu.
Step 2: The article should appear in the window, make changes and click on “SUBMIT”.
   Promotions Admin

Coupons

Creating a New Custom Coupon
Step 1: Select the Type of Coupon from the dropdown menu.
Step 2: Enter Specific Part Number (If product specific).
Step 3: Enter Coupon Number.
Step 4: Select the Coupon Amount Type from the dropdown menu.
Step 5: Enter the Percent Off (If Percent Off).—Do not use decimals.
Step 6: Enter Amount Off (If Specific Amount Off).
Step 7: Enter Expiration Date.
Step 8: Click “create.”

Editing an Existing Coupon
Step 1: Selecting the coupon you want to edit from the pull down menu.
Step 2: Click the “edit” button.
Step 3: Make any edits and save the coupon.

Bulk Email

To Send Bulk Email
Step 1: Enter who the email is from in the “From:” field.
Step 2: Enter the Subject
Step 3: Upload an image for header
   To upload an image:
      1. Click on the “Browse” button.
      2. Locate and select on your computer where the image is.
      3. Click on the “Open” button.
      4. Click on the “Upload” button.
Step 4: Type or paste the body of your email into the “Email_Content”.
To change the font, font size, justification, font color, etc., use the tool bar directly above the content window.
Step 5: Click on “Preview” to preview your email.
Step 6: If you have any changes, click on the “Edit” button. Make any necessary edits and save.
Step 7: Click on the “Email” button to send the email out to list.
   Private Label Admin

Assigning Private Label Parts
Step 1: Select a company from the pull down menu on the left hand side of the screen and click on the “assign specialty parts” link below.
Step 2: Enter Part Number and press “Go.”
   In the “Part# Description” section you can sort the parts by “Description”, “Part#”, and “Category” by selecting the option you want and pressing the “Sort” button.

Editing a Private Label Part
Step 1: Highlight the part you want to edit and click on the “EditParts” button.
Step 2: The next screen should have a table where you can edit the Part#, Description, Weight, etc. Make your changes here.
Step 3: Press the “GLOBAL UPDATE” button to save changes.

Deleting a Private Label Part
Step 1: Highlight the part you want to delete and click on “Delete Parts”.
Step 2: You will go to a page that will ask to confirm if you want to delete the part, click on the button to confirm and delete.
   Categories Admin

Category Administration

To EDIT a Parent Category
Step 1: Select the category from the pull down menu and click on “Edit.”
Step 2: In the “Category Maintenance Screen”, make any changes.
Step 3: To add a category to the level enter the category and click on “ADD”.
Step 4: When changes are complete, click on “update” to continue.

To ADD a New Category
Step 1: Enter AAIA_ID and the category name.
Step 2: Click “ADD.”
   Suppliers Admin

Suppliers Administration

To Edit Companies or Parts
Step 1: Click on the company name link to open up an “Order Administration Screen.” In this screen you can assign IDs or Card Codes to the individual company. Click on “ReAssign” to complete changes.
Step 2: Click on the “edit” button to edit part numbers.
   To Edit a Single Part Number
   Enter the part# and press “Go.”
   To Edit Multiple Part Numbers
   Either do a search by part numbers, or sort the list by category choices.
   To Select More Than One Part
   Hold down the Control [CTRL] button on the keyboard while you click on the parts you want to highlight. Click on the “EditParts” button to make your changes, click on “DELETEParts” to delete parts.

Company Segments

To View Company Segments
Step 1: Click on the link for “company segments.”
Step 2: To view or change company data, click on the company name.
Step 3: Enter any altered data and click on “ReAssign” to update.
Step 4: To change active status, click on the appropriate link.

Category Segments

To View Category Segments
Step 1: Click on the link for “category segments.”
Step 2: Click on the category link.
Step 3: Make any changes in the screen.
Step 4: For changes in Category names, simply click on the link of the category that you want to change and make any edits in the next screen.
Step 5: Click “Add” to update

Suppliers

Adding New Suppliers
Step 1: Select a manufacturer from the pull down menu and click “ADD.”

Editing Suppliers
Step 1: Select a manufacturer from the pull down menu and click “EDIT.”
Step 2: In the next screen, make any necessary changes and click “UPDATE.”
   Dealers Admin

Price Levels

Adding a Price Level
Step 1: Input Price Level (e.g., Stocking jobber, etc.).
Step 2: Input Percentage off.
Step 3: Select which price option from the pull down menu.
Step 4: Click on “ADD PRICING.”

Editing Price Level
Step 1: Select the price level you want to edit from the pull down menu and select “EDIT” to edit or “DELETE” to delete.
Step 2: Make any necessary changes in the Edit window and click “UPDATE.”

Dealers

Adding a New Dealer
Step 1: Click on the link that says “Add a New Dealer.”
Step 2: The next screen will have fields for you to fill out. Enter the appropriate information in the fields.
Step 3: Click on “ADD DEALER.”

Editing a Dealer
Step 1: Select a dealer from the pull down menu and click on the “EDIT” button.
Step 2: In the next screen, make any necessary changes and click on “UPDATE DEALER.”

Deleting a Dealer
Step 1: Select a dealer from the pull down menu.
Step 2: Click on “DELETE DEALER” to remove this dealer from database.

Assigning Levels/Discounts

Assigning Price Levels
Step 1: Select the Dealer that you want to assign price to.
Step 2: Select the Price Level.
Step 3: Click on “Assign.”

Assigning Payment Methods
Step 1: Select the Dealer.
Step 2: Select the Payment Method.
Step 3: Click on “Assign.”

Adding a Product Line Discount
Step 1: Select the Dealer.
Step 2: Enter the percentage off and select the price from the dropdown menu.
Step 3: Select the Product Line.
Step 4: Click on “Assign.”

Removing Product Line Discounts
Step 1: Select the product line discount.
Step 2: Click on “REMOVE.”
   Shopping Cart Reports

Companies

Top Selling Company
Step 1: To view the top selling company, click on the link that reads “top selling companies.”
Step 2: Copy and Paste data into an Excel Spreadsheet to manipulate the data better.

Parts Sold
Step 1: To see what parts have been sold, click on the link that reads “parts sold.”
On the next page, a chart appears containing all the data of the parts sold, sorted by company name.
   Review & Export Data
Step 1: To export data, click on the appropriate link for the information that you want to export.
Step 2: A File Download window will appear, click on “Open” to open the file directly in an Excel window, click on “Save” to save the file to disk—your computer or a floppy, etc.

While the embodiments have been described with reference to specific features and elements in various configurations, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead includes all possible embodiments falling within the scope of the appended claims.

What is claimed is:

1. A method for facilitating commerce, the method comprising:
allowing a user to select one or more items from a list presented to the user;
associating the one or more items with at least one alias;
mapping the one or more items into a preselected format; and
cataloging the mapped data so that it can be accessed by at least the user,
wherein the mapped data is integrated with a storefront so that the items may be located and sold using the mapped data.

2. The method of claim 1, further comprising the step of exporting the data to an e-commerce platform so the data can be used for the purchase of the one or more items.

3. The method of claim 1, wherein the parts are vehicle aftermarket parts.

4. The method of claim 1, wherein the storefront is an e-commerce storefront based on a network.

5. The method of claim 1, wherein the preselected format is the AAIA industry standard compliant cataloging format.

6. The method of claim 1, wherein the preselected format is selected by the user.

7. The method of claim 1, further comprising the steps of:
associating the one or more items with one or more aliases; and
allowing the user to map the one or more selected items by the one or more aliases.

8. The method of claim 1, wherein the data is exported in a format compatible with commercially available ecommerce web sites and software applications.

9. A system for facilitating commerce over a computer based network comprising:
allowing a user to select one or more items from a list presented to the user;
associating the one or more items with at least one alias;
mapping the one or more items into a preselected format; and
cataloging the mapped data so that it can be accessed by at least the user,
wherein the mapped data is integrated with a storefront so that the items may be located and sold using the mapped data.

10. The system of claim 9, further comprising exporting the data to an e-commerce platform so the data can be used for the purchase of the one or more items.

11. The system of claim 9, wherein the parts are vehicle aftermarket parts.

12. The system of claim 9, wherein the storefront is an e-commerce storefront based on a network.

13. The system of claim 9, wherein the preselected format is the AAIA industry standard compliant cataloging format.

14. The system of claim 9, wherein the preselected format is selected by the user.

15. The system of claim 9, further comprising:
associating the one or more items with one or more aliases; and
allowing the user to map the one or more selected items by the one or more aliases.

16. The system of claim 9, wherein the data is exported in a format compatible with commercially available ecommerce web sites and software applications.
